(19) United States
(12) Patent Application Publication
(10) Pub. No.: US 2002/0197967 A1
(43) Pub. Date: Dec. 26, 2002

(54) Communication system with system components for ascertaining the authorship of a communication contribution

(76) Inventors: Holger Scholl, Herzogenrath (DE); Andreas Kellner, Aachen (DE)

Correspondence Address: U.S. Philips Corporation, 580 White Plains Road, Tarrytown, NY, 10591, US

(21) Appl. No.: 10/175,409

(22) Filed: Jun. 19, 2002

(30) Foreign Application Priority Data
Jun. 20, 2001 (DE) 10129662.2

(51) Int. Cl. H04B 1/04

(52) U.S. Cl. 455/118; 455/131

(57) ABSTRACT

The invention relates to a communication system with system components for ascertaining the authorship of a communication contribution (40, 41) put in into a communication end device through

evaluation of a video signal by pattern recognition, and/or

speaker identification through evaluation of an audio signal, and/or

determination of a relative position of the author (50) among communication participants registered as participants (50, 61 to 66) using said communication end device.

In addition to the authorship of a contribution (40, 41), the mood of the author (30, 31, 50) may also be determined. The communication system is constructed such that it represents a contribution (40, 41) in a manner which characterizes the author (30, 31, 50) of the contribution (40, 41) and/or his/her mood.

The invention relates to a communication system with system components for ascertaining the authorship of a communication contribution. Communication systems are used in many locations, for example as audio/video and/or text conference systems in both business and private applications. In particular, the services supported by the Internet protocol such as chatting, NetMeeting, application sharing, and other similar groupware products have become increasingly popular in recent times.

The communication systems may then transmit spoken language, still and moving pictures, texts, control commands, and the like. Possibilities may be created therefrom by means of suitable systems which render it possible for the communication participants to interact with one another approximately in a manner as if they were in one and the same location. Thus, for example, sketches of professional designs can be transmitted in addition to the spoken words and the moving images of the participants.

If more than two persons take part in such a communication, it may be difficult for a given participant, depending on the circumstances, to determine from which other participant a communication contribution originates. Thus, for example, in an audio conference the allocation of the voice of a speaker to the name of a participant may lead to problems if the participants have not known each other for a long time. Furthermore, it is useful for documentation purposes if the communication system records the authorship of the contributions and stores them together with the contributions, for example for subsequent use as evidence or for evaluation. Ascertaining the authorship of a contribution may indeed also be useful for this purpose if all communication participants are in the same location. To save transmission bandwidth, several systems also transmit, for example, no full moving pictures of the participants but only gesture and facial expression descriptions, which will then be converted into movements of artificial characters, so-called avatars, associated with the participants on the participants' devices.

It is necessary for these and similar known systems that the communication system is able to determine from which participant a communication contribution originates. Thus DE 197 24 719 A1 describes an audio conferencing system whose communication devices are equipped with a microphone device and an audio level detection device. The audio level detection device detects the audio level received by the microphone device. If this audio level is above a given value, the end device transmits the audio input characterizing signal to the other end devices of the audio conferencing system for indicating the audio input. The end devices then indicate the authorship of a contribution on a display device in accordance with these audio input characterizing signals.

DE 197 24 719 A1 is thus based on the fact that one communication participant is unequivocally associated with each end device, i.e. it provides a solution only to the question from which end device a communication contribution originates. If several participants use the same end device, however, for example the participants in a telephone conference present in one room and using the same telephone with hands-free function, the identification merely of the end device from which a contribution originates is insufficiently precise. DE 197 24 719 A1 further requires the end device to ascertain itself whether a contribution originates from it, and that it will communicate this subsequently to the other end devices. If, for example, an audio conferencing system is to be offered as a so-termed application service, for example via the Internet, it is desirable also to support simple end devices which may be formed, for example, merely by a PC with an audio card and a microphone/loudspeaker combination, or alternatively only by a telephone.

It is accordingly an object of the invention to provide a communication system of the kind mentioned in the opening paragraph which renders it possible to determine the authorship of a communication contribution also if several participants use the same end device and/or the determination of the authorship is to be achieved by the end device from the contribution itself without special support.

This object is achieved on the one hand by means of a communication system with system components for ascertaining the authorship of a communication contribution put in into a communication end device through

evaluation of a video signal by pattern recognition, and/or

speaker identification through evaluation of an audio signal, and/or

determination of a relative position of the author among communication participants registered as participants using said communication end device, and on the other hand by means of a method of ascertaining the authorship of a communication contribution put in into a communication end device through

evaluation of a video signal by pattern recognition, and/or

speaker identification through evaluation of an audio signal, and/or

determination of a relative position of the author among communication participants registered as participants using said communication end device.

For example, if a video signal of the communication participants is transmitted, methods of image processing and pattern recognition may be used so as to ascertain who is the initiator of the contribution. Thus, for example, it may be ascertained through recognition of the lip movements or an analysis of visual scenes who is speaking at the moment, is entering an input through a keyboard, or is operating a writing pad connected to the end device. The methods of speaker identification through evaluation of an audio signal based, for example, on statistical methods such as Gaussian mixing models or so-termed Hidden Markov Models render it possible to determine the author of an audio contribution. The evaluation of a video signal through pattern recognition and the speaker identification through evaluation of an audio signal may also be applied purely to the contribution itself and may be implemented without support by a specially equipped end device.

If several participants use the same end device, the use of a sensor may serve to determine the relative position among said participants of that participant who is operating the end device at that moment for generating the contribution. The relative positions can be unequivocally linked to the participants in that, for example, at the start of a telephone conference, when the participants using the end device are registered, the relative positions of these participants are communicated to the system and are subsequently utilized by the system. The originator of the contribution is accordingly determined from the relative position.

According to claim 2, suitable sensors for this are a camera, a microphone, a radio receiver, and/or an infrared receiver. In some cases the participants must then carry additional equipment such as, for example, a transponder for radio contact and/or an infrared signal generator for infrared contact. A plurality of sensors, for example in the form of microphone arrays, as a rule leads to an improvement of the quality of such localization systems. If only a single microphone is used without further sensors, a movable microphone with directional characteristic may be used, by means of which the direction from which a participant speaks, and thus the participant himself/herself, can be determined.

The methods of ascertaining the authorship according to the invention can be used not only singly, but also in numerous combinations. For example, if the input of a text contribution is made through a keyboard, the video signal of a camera may be supplied to a pattern recognition unit which determines to which participant the hands operating the keyboard belong, and which subsequently determines the identity of the respective participant through recognition of the facial characteristics of the participant belonging to the hands. On the other hand, the video signal may also be used for tracking the relative positions of the participants such that it is known which participant is at the keyboard. If the participants carry transponders or infrared signal generators, this determination of the relative position may also be achieved through radio or infrared-based localization systems. All the possibilities can be used in combination with one another.

If there is a spoken contribution, a speaker identification may be carried out on the one hand through evaluation of the audio signal. On the other hand, however, a microphone array may be used for determining the direction from which the audio contribution has come. Furthermore, the evaluation of the video signal of a camera observing the participants can be utilized through pattern recognition for determining whose lips are moving in synchronity with the audio signal. Transponders and infrared signal generators may also be used again.

The dependent claims 3 to 6 relate to the situation in which the communication system uses the authorship information of the contribution for a corresponding characterization thereof. The nature of the characterization may then depend on further criteria such as, for example, the level of importance or the contribution frequency of the originator and/or on special wishes of the participants. Apart from the authorship itself of a contribution, the communication system may also determine the mood of the author of the contribution through pattern recognition and provide the contribution with a characterization of such a mood.

The dependent claim 7 claims an embodiment of the communication system according to the invention which is capable of storing a communication contribution, its author, and/or his/her mood. Such a permanent documentation of a communication is of major value in particular in the case of business negotiations. Thus, for example, any decisions made may be documented in their original form.

The dependent claims 8 and 9 relate to embodiments of the invention in which the authorship of a contribution is pinpointed on the one hand in a central device of the communication system and on the other hand in a participant device, for example in the communication end device. The determination of the authorship in a central device is particularly suitable for the application service providers mentioned above, who can offer such a communication system as an application service, for example via the Internet. On the other hand, some embodiments of the invention such as, for example, the microphone arrays require a special equipment of the devices at the participants' end. The determination of the authorship of the contributions at the participants' end will save transmission bandwidth if not the individual microphone signals, but instead, for example, only a signal averaged over the microphones is transmitted.

These and further aspects and advantages of the invention will be explained in more detail below with reference to embodiments and in particular with reference to the appended drawings, in which:

FIG. 1 shows an embodiment of a communication system according to the invention,

FIG. 2 shows an embodiment of a representation of the communication contributions characterizing the originators in a communication system according to the invention,

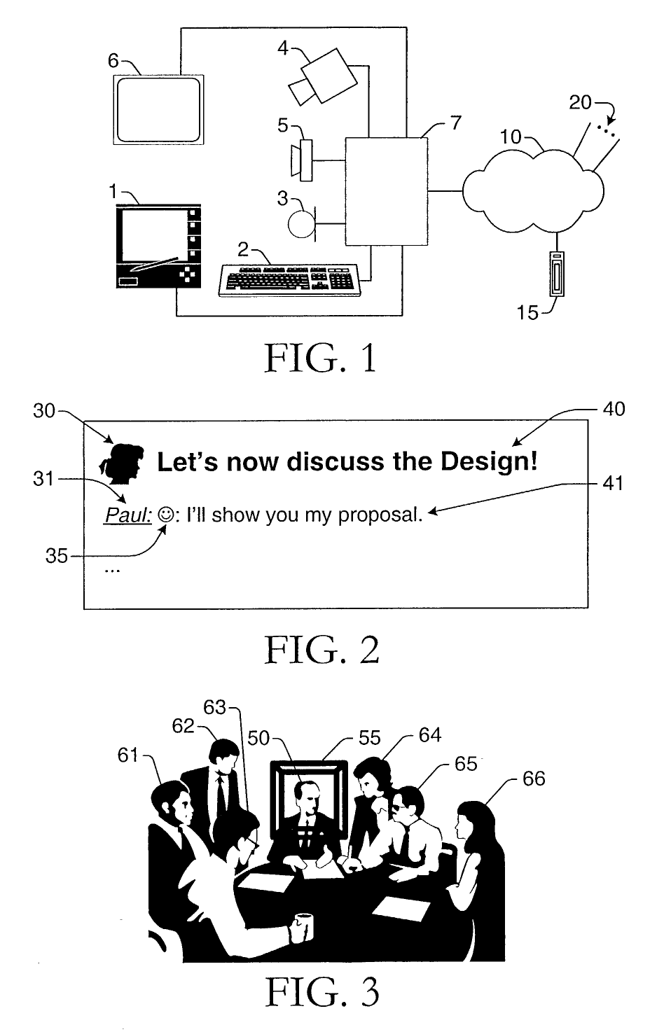

FIG. 3 shows an embodiment of a characterization of the originator of the current communication contribution in a communication system according to the invention, and

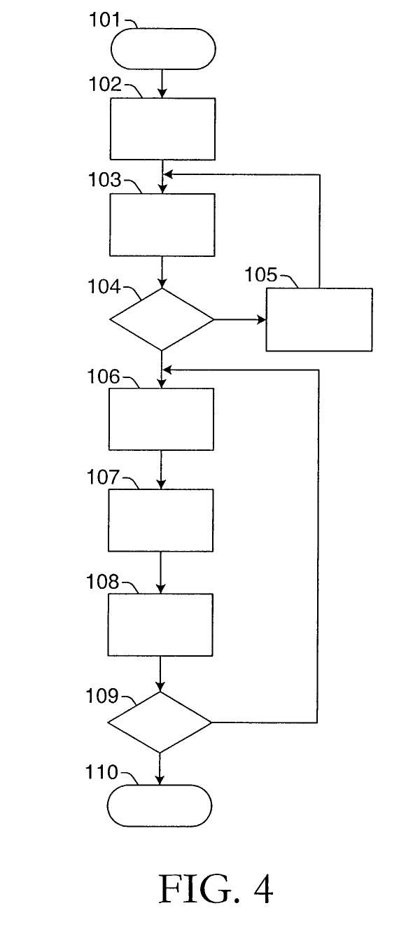

FIG. 4 diagrammatically shows the sequence of a communication in a communication system according to the invention in the form of a flowchart.

FIG. 1 shows an embodiment of a communication system according to the invention. An end device present in a location at the participant's side comprising the components 1 to 7 is connected via a network 10 to further participant end devices 20 and, in this embodiment, to a central device 15 of the communication system. The network 10 may here be the public telephone network, a mobile telephone network, the Internet, a company network, or the like. The central device 15 in this embodiment is designed for receiving the communication contributions from the end devices, for ascertaining their authorship, and for displaying the contributions with corresponding indicators as to their authorship on the end devices.

A participant end device may then comprise the components 1 to 7. A writing pad 1, a keyboard 2, a microphone 3, and a camera 4 are components for the input of communication contributions and/or for obtaining information used by the communication system for ascertaining the authorship of a contribution. A loudspeaker 5 and a display 6 serve for an acoustical and/or optical display of the contributions and for characterizing their authors. The components 1 to 6 are connected to a processing unit 7 at the participants' end, which controls the data flow to and from the components 1 to 6 and establishes the connection with the network 10.

In this embodiment, the processing unit 7 passes on the data coming in from the input components 1 to 4, via the network 10 to the central device 15, and it passes on data coming from the central device 15 to the respective output components 5 and 6. In principle, the processing of the data might also be shared between the processing unit 7 at the participants' end and the central device 15. In an extreme case, the central device 15 may be fully absent, and the entire data processing could be taken over by the processing unit 7 at the participants' end. The data quantity to be transported over the network 10 could be reduced in that case. The embodiment shown in FIG. 1 with a central device 15, which looks after the determination of the authorship, the formatting of the characterization, and the display of the contributions, however, offers the advantage that the processing intelligence necessary for this can be readily made available, maintained, and expanded in a central location.

FIG. 2 shows an embodiment of a display of the communication contributions characterizing the originators in a communication system according to the invention. A display of the communication contributions in the form of text is shown, for example on a display 6. The contributions may originally be directly entered in text form, for example through the keyboard 2, or an intermediate pattern recognition system may have been used for converting handwriting put in via the writing pad 1 or speech put in via the microphone 3 into written text.

The text is continuously represented, for example in time sequence, as is known from chatting systems. FIG. 2 shows the two text contributions 40 “let's now discuss the design!” and 41 “I'll show you my proposal.”. Different letter types are used in the display of the text contributions for distinguishing them from one another. The text contribution 40 is printed in larger type and bold, for example for emphasizing the importance of its author, who may be, for example, the leader of the discussion.

The originators of the contributions, however, are also identified by the origin indicators 30 and 31 preceding the texts. The example used here is a sketch of a female profile 30 known from clip art pictures, and on the other hand the Christian name 31 “Paul” of the originator. Alternative origin indicators are conceivable such as, for example, pictures of the participants in the communication, possibly in stylized form, or company logos, if the communication takes place between different companies.

Finally, the text contribution 41 is provided with a so-termed emoticon 35, a smiley in this case, i.e. a picture of a smiling face. Such aids may be used, for example, for indicating the mood of a communication participant to the other participants. Such moods may be either put in explicitly by an originator of a contribution or be determined by a pattern recognition system. The mood recognition may be carried out, as can the authorship of a contribution, both in a component 7 at the participants' side and in a central device 15 of the communication system from the incoming data flow of the contribution, as required.

FIG. 3 shows an embodiment of a characterization of the author of the current communication contribution in a communication system according to the invention. The participants 50 and 61 to 66 in a discussion are shown in the form of sketches, for example so-termed avatars, on a display 6. The display of the avatars may be static in the simplest case. It is alternatively possible, however, to use video information recorded by cameras 4 for animating the avatars, indicating at least approximately the actual movements of the participants. A frame 55 is used in FIG. 3 for indicating the author of the currently displayed contribution.

A possible scenario is, therefore, that the participant 50 is speaking at this moment and his spoken contribution recorded by a microphone at his communication location is communicated to the other communication locations through the loudspeakers 5. The central device 15 then uses speaker identification through evaluation of the audio signal so as to ascertain who is the originator of the spoken contribution and transmits to all end devices the information that this is the participant referenced 50. Said end devices then mark the speaker 50 with the frame 55 and display the picture of the conference on the displays 6.

A communication system according to the invention is then designed such that the manner of representing contributions from the participants at the display side can be influenced. The participants may thus introduce their own personal preferences and, for example, characterize text contributions with the name or with a picture of the authors.

FIG. 4 diagrammatically shows the sequence of a communication in a communication system according to the invention in the form of a flowchart. The communication system according to the invention is switched on in the start block 101, and the communication link between the participant locations is established. Then the communication participants make themselves known to the system in process block 102, and the system stores their identification data in block 103 and starts the tracking of the participants. Depending on the technique and knowledge of the system used, it may be that the system requires further data, which is tested in decision block 104.

A speaker identification system for ascertaining authorship requires, for example, a certain quantity of spoken material from each speaker so as to distinguish the speakers from one another. If, for example, new speakers unknown to the system participate in the communication, the system will require and obtain additional information from the participants in block 105, which is stored again in block 103. Another possibility is, for example, that speakers taking part in the communication have voices which are too similar, so that they cannot be reliably distinguished from one another in a larger quantity of voice material. In this case, the system may have recourse to further identification facilities available to it such as, for example, image recognition and/or localization by means of microphone arrays or transponders. If the system does not have these alternative possibilities, some other error treatment not discussed here is to be used.

Once the test in block 104 has ascertained that the system contains sufficient information for identification of the participants, possibly after traversing the steps 103 and 105 several times, the control is passed on to block 106 where one or several participants provide their communication contribution(s). In block 107, the system identifies the authors of the received contributions and/or their moods and utilizes this information in block 108 for transfer and for a display of the contributions in all communication locations. If the participants are moving, it may be useful for identification here if the system also follows the movements of the participants so as to safeguard an unequivocal interrelationship between the location of a participant and his or her identity. The implementation of the steps 106 to 108 should overlap in time, in particular in the case of longer contributions, for obtaining a smooth representation of the contributions, their authors, and their moods.

It is finally tested in block 109 whether further communication contributions are to be transmitted. If so, the control returns to block 106. If not, the communication system is de-activated and switched off in end block 110. The communication links between the locations are cut off in a defined manner, and a protocol of the communication sitting, i.e. a copy of the communication contributions, their authors, and their moods may be permanently stored, for example for documentation purposes, if so desired.

1. A communication system with system components for ascertaining the authorship of a communication contribution (40, 41) put in into a communication end device through
evaluation of a video signal by pattern recognition, and/or
speaker identification through evaluation of an audio signal, and/or
determination of a relative position of the author (50) among communication participants registered as participants (50, 61 to 66) using said communication end device.

2. A communication system as claimed in claim 1, characterized in that the communication system comprises a camera (4) and/or a microphone (3) and/or a radio receiver and/or an infrared receiver for determining the relative position of the author (50).

3. A communication system as claimed in claim 1 or 2, characterized in that the communication system is designed for displaying a contribution (40, 41) in a manner (30, 31, 55) which characterizes the author (30, 31, 50) of the contribution (40, 41).

4. A communication system as claimed in claim 3, characterized in that the communication system is designed for accentuating a contribution (40) of a frequent and/or important author (30) as opposed to a contribution (41) of an infrequent and/or unimportant author (31).

5. A communication system as claimed in any one of the claims 1 to 4, characterized in that the communication system is designed for recognizing a mood of an author (31) of a contribution (41) and/or for displaying a contribution (41) in a manner (35) which characterizes the mood of the author (31) of the contribution (41).

6. A communication system as claimed in one of the claims 3 to 5, characterized in that the communication system is designed such that a communication participant (30, 31, 50, 61 to 66) can influence the characterization of a contribution (40, 41).

7. A communication system as claimed in any one of the claims 1 to 6, characterized in that the communication system is designed such that a contribution (40, 41) and/or the author (30, 31, 50) of the contribution (40, 41) and/or his/her mood are stored.

8. A communication system as claimed in any one of the claims 1 to 7, characterized in that a central device (15) of the communication system is constructed as a system component for determining the authorship of a communication contribution (40, 41).

9. A communication system as claimed in any one of the claims 1 to 7, characterized in that a device (7) at the participants' end of the communication system is constructed as a system component for determining the authorship of a communication contribution (40,41).

10. A method of ascertaining the authorship of a communication contribution put in into a communication end device through
evaluation of a video signal by pattern recognition, and/or
speaker identification through evaluation of an audio signal, and/or
determination of a relative position of the author among communication participants registered as participants using said communication end device.
